(19) United States
(12) Patent Application Publication
(10) Pub. No.: US 2007/0255650 A1
(43) Pub. Date: Nov. 1, 2007

(54) Migration between bill payment processors

(76) Inventors: Charles Eric Destrempes, Los Altos, CA (US); Julia Patterson, Santa Clara, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/413,462

(22) Filed: Apr. 28, 2006

(51) Int. Cl. G06Q 40/00

(52) U.S. Cl. 705/39

(57) ABSTRACT

Systems and methods for migration between payment processors. A user sets-up payments with a financial institution using a client module (e.g., a personal finance manager). The client module sends the transaction data to an entity such as a bank OFX server and receives a first transaction identifier for use when making transaction requests. A migration module can initiate a migration process from the bank OFX server to an independent OFX server. The migration module can cancel payments at the bank OFX server and reconfigure on the independent OFX server. The migration module stores a second transaction identifier received from the independent OFX server. When the user subsequently makes a manual payment or updates payee information, the migration module switches the first transaction identifier with the second transaction identifier, and before forwarding to the independent OFX server.

### BACKGROUND

The present invention relates generally to software tools for financial services.

Paying bills is a time-consuming, and frequent process. The advent of application software for bill payment on the front-end, and of payment processing systems on the back-end, has automated the bill payment process. Generally, the bill payment software provides a user interface for entering account and payment information, and setting up periodic payment instructions. As a result, and in some cases without further user input, the payment software automatically submits the payment instructions to the payment processing system. In turn, the payment processing system submits payments via, for example, the Automated Clearing House (ACH) network which provides interbank regulations and clearing of batched payments.

Although seamless to the user, the bill payment process typically requires coordination between the bill payment software and the payment processing system, over a period of time. More particularly, the bill payment software submits payment transactions to the payment processing system, either directly, or through an intermediary, such as the user's bank. The payment processing system draws funds (e.g., via the ACH) from a funding source for disbursement of funds to the payee (e.g., by check or electronic transfer). After the payment has been sent to the payee, a confirmation is sent from the payment processing system to the bill payment software.

One problem with maintaining bill payments that are seamless to a user occurs when changing from an existing payment processing system to a different one. Conventionally, when there is a change in the payment processing system, a user of the bill payment software may have to manually delete and recreate payment information. Because the current provider maintains server identifications that map bill payments to specific servers, a new provider would have difficulty in acting as a substitute unless the user reconfigures payment information with the new provider.

### SUMMARY

The present invention provides systems and methods for migration between payment processors. In one embodiment, a user sets up payments with a financial institution using a client module (e.g., a personal finance manager). The client module sends the transaction data to an entity such as a bank OFX server and receives a first transaction identifier for use when making transaction requests. A migration module can initiate a migration process from the bank OFX server to an independent OFX server. The migration module can cancel payments at the bank OFX server and reconfigure on the independent OFX server. The migration module stores a second transaction identifier received from the independent OFX server.

In one embodiment, when the client module subsequently makes transaction requests (e.g., a manual payment or updates payee information), the migration module processes transaction requests to determine whether there is a payment request that has been migrated. For migrated payments, the migration module switches the first transaction identifier with the second transaction identifier, before forwarding to the independent OFX server. For transaction requests that are not payment requests, the transaction can be forwarded to the bank OFX server.

As a result, a provider of a payment module can change between payment processors without burdening end-users. In other words, the user of the client module is not required to cancel and reconfigure payments with the new payment processor.

The features described herein are not all inclusive, and, in particular, many additional features will be apparent to one skilled in the art in view of the drawings, specifications, and claims. Moreover, it should be noted that the language used in the specification has been principally selected for readability and instructional purposes and may not have been selected to circumscribe the claimed invention.

### BRIEF DESCRIPTION OF THE DRAWINGS

FIG. 1 is a block diagram illustrating a system for making transaction requests, before migration, to a payment processor according to one embodiment of the present invention.

FIG. 2 is a block diagram illustrating a system for seamlessly migrating payment transactions between payment processors according to one embodiment of the present invention.

FIG. 3 is a block diagram illustrating a migration module of the system in further detail according to one embodiment of the present invention.

FIGS. 4A-B illustrate samples of pseudo code used in a transaction request and a modified transaction request according to one embodiment of the present invention.

FIG. 5 is a flow chart illustrating a method for seamlessly migrating between payment processors according to one embodiment of the present invention.

FIG. 6 is a flow chart illustrating one embodiment of a method for redirecting transaction requests according to one embodiment of the present invention.

FIG. 7 is a flow chart illustrating one embodiment of a method for redirecting payment requests according to one embodiment of the present invention.

One skilled in the art will recognize that these Figures are merely examples of the operation of the invention according to one embodiment and that other configurations and modes of operation can be used without departing from the characteristics of the invention.

### DETAILED DESCRIPTION

Systems and methods for migrating payment transactions between payment processors are described. Payment transactions can include, for example, bill payments, paycheck payments, or other financial disbursements. Data related to the payment transaction can indicate a payment processor for handling the transfer of funds from a payor to a payee, and includes data received from the payment processor that is needed to carry out the transfer. The payment transaction data can be formatted using, for example, the open OFX (Open Financial Exchange) format or the proprietary NPC (National Payment Clearinghouse) format which are used for exporting information from a bank to a client operated by a user, or format which facilitates financial information exchange. In one embodiment, the payment transaction data is unique to an original payment processor, and thus, a migration process requires cooperation from the original payment processor. In one embodiment, the systems and methods described herein are able to handle payment transactions through the new payment processor using information provided by the old payment processor.

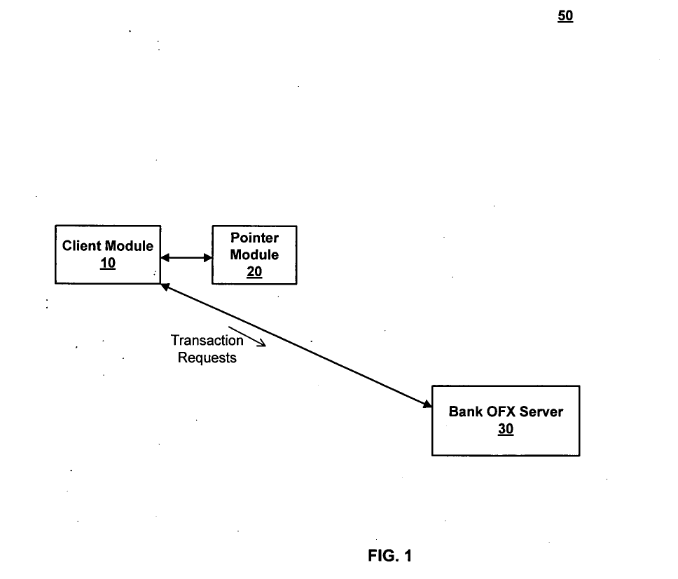

FIG. 1 is a block diagram illustrating a system 50, prior to migration, in which client module 10 submits a transaction request to a bank OFX server 30. From time to time, a financial institution adds server capacity and reorganizes which servers handle particular users. A pointer module 20 can be provided to maintain a current location of bank OFX server 30 assigned to handle transactions for the user.

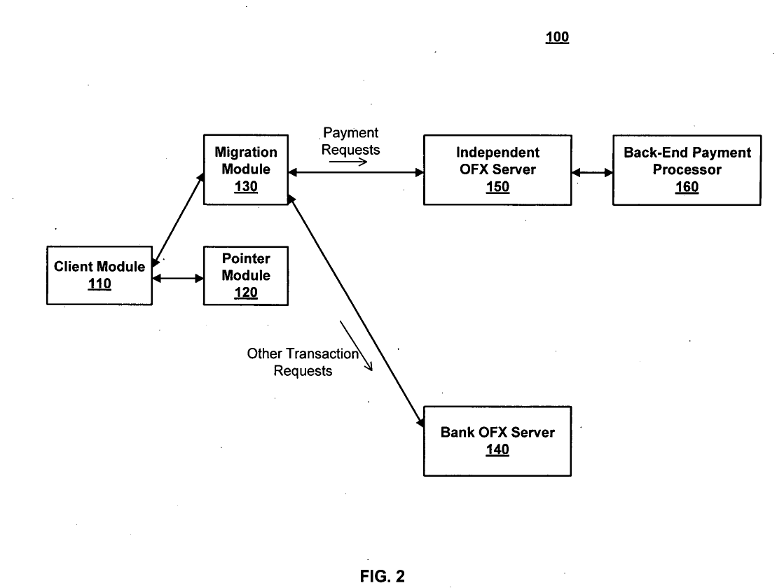

FIG. 2 is a block diagram illustrating a system 100 for seamlessly migrating payment transactions according to one embodiment of the present invention. System 100 comprises a client module 110, a pointer module 120, a migration module 130, a bank OFX server 140, an independent OFX server 150, and a back-end payment processor 160. The components of system 100 are coupled in communication through a network such as a data network (e.g., the Internet) and/or a telephone network. The components can be, for example, software code executing locally on a personal computer or other electronic device, software code executing remotely on a server and presented through a web client (e.g., an online banking service). Note that the components are merely representative of functionality which can vary in physical implementation. At a high-level, system 100 migrates payment transactions from bank OFX server 140 to independent OFX server 150. The migration process is seamless to client module 110. For example, a user sets-up a recurring bill payment with bank OFX server 140 and client module 110 continues to operate as such, even when the bill payments are subsequently migrated to the independent OFX server 150.

Client module 110 can send and receive the payment transaction data. Client module 110 can be a financial software application such as a personal financial manager (PFM) or a bill payment application. In one embodiment, client module 110 provides access for a user to services offered by bank OFX server 140. For example, the user can enter a payee, an account number, payment amounts and other information related to the bill payments. Accordingly, client module 110 can automatically marshal an electronic payment for the predetermined amount at the predetermined time, without further intervention by the user. To provide automated payment services, client module 110 generates a payment request and processes a payment response using, for example, the OFX format. A transaction universal identifier of the OFX format allows client module allows client module 110 to correlate a received response to a sent request.

Prior to migration, client module 110 is directed by pointer module 120 to conduct financial transactions, including payment transactions, with bank OFX server 140 (e.g., via a URL). From the perspective of client module 110, financial transactions continue to be conducted with bank OFX server 140 subsequent to migration. In actuality, selected financial transactions are now conducted with independent OFX server 150 via migration module 130. In one embodiment, client module 110 is unaware of the back-end change. Thereby, the migration process is seamless to the user of client module 110 (i.e., does not require configuration by the user or by client module 110).

Pointer module 120 can receive the transaction request from client module 110, and return location data. In one embodiment, pointer module 120 can be a service of the manufacturer of client module 110. Pointer module 120 maintains current locations for bank OFX servers, and provides the location data for a particular transaction. The location data can be, for example, a URL or other network address. Before migration, the location refers to bank OFX server 140. In addition, pointer module 120 can authenticate client module 110 using, for example, a challenge-response process. After migration, the location information refers to migration module 130, regardless of the designated bank OFX server.

Migration module 130 can receive the transaction requests from client module 110, and send modified transaction requests to bank OFX server 140 and independent OFX server 150. One embodiment of migration module 130 is described below in association with FIG. 2. In one embodiment, migration module cancels payments with OFX server 140 and establishes payments with back-end payment processor 160. When a transaction request is received, migration module 130 identifies which of the transaction requests are payment requests, and redirects payment transactions to independent OFX server 150. Additionally, migration module 130 can continue to direct other transactions requests to bank OFX server 140. After processing of the transaction requests, migration module 130 remaps responses from independent OFX server 150 so that they are recognizable by client module 110 (e.g., using at least a portion of the original financial transaction data).

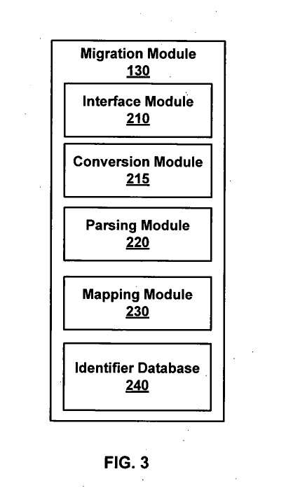

Bank OFX server 140 can receive transaction requests, and send transaction responses. One embodiment of bank OFX server 140 is described below in association with FIG. 3. Bank OFX server 140 can be operated by a bank or an online financial company (e.g., E-Trade). Prior to migration, bank OFX server 140 processes transaction requests including payment requests using its own back-end service. The back-end service in turn uses ACH, EFT, SWIFT, or other services to transfer funds. During migration, bank OFX server 140 sends information needed to carry out the payment request to migration module 130 (e.g., payee information, account numbers, and payment amounts), and cancels future payments. In one embodiment, the information can be automatically extracted from bank OFX server 140 even without its knowing cooperation (i.e., bank OFX server 140 has not been configured to assist migration to another service). After the migration process begins redirecting migration requests to independent OFX server 150, bank OFX server 140 can continue to process other transaction requests. Examples of other transaction requests include PIN number changes, balance requests, wire transfers, and fund transfers.

Independent OFX server 150 can be operated by a third-party that is dedicated to handling payment requests. Independent OFX server 150 configures and tracks payments on behalf of client module 110. In one embodiment, independent OFX server 150 processes payments by submission to back-end system 160. Back-end system 340 ensures that a payee receives funds in line with federal guidelines.

FIG. 3 is a block diagram illustrating one embodiment of migration module 130 in further detail. Migration module 130 comprises a parsing module 210, a conversion module 215, a mapping module 220, a migration database 230, and an interface module 240.

In one embodiment, parsing module 210 determines whether the transaction request received is a payment request or is a request for another banking transaction. Parsing module 210 can access, for example, header descriptions, templates, or other characteristics of bill payments to be used for identifying bill payments. Transactions that are not identified as bill payments can be assumed by parsing module 210 to be other banking transactions, or alternatively, parsing module 210 can positively identify the other banking transactions using header, for example, header descriptions.

After initializing migration, conversion module 215 cancels old payments and configures new payments. Conversion module 215 retrieves transaction data from bank OFX server 140 and cancels future payments. Conversion module 215 also sends transaction data to independent OFX server 150 to implement future payments. A first transaction identifier used by client module 110 is associated with a second transaction identifier recognized by independent OFX server 150, and stored in identifier database 230. Identifier database 230 can be a single database or several databases that store formatted data (e.g., a table of first and second payment identifiers). In a real-time mode, the identification information is retrieved from bank OFX server 140 on-the-fly, when a payment request is received. In batch mode, the information is retrieved from OFX server 140 in batch mode during low usage time periods (e.g., overnight or weekends). In hybrid mode, the identification information is retrieved in partially in batch, and partially on-the-fly.

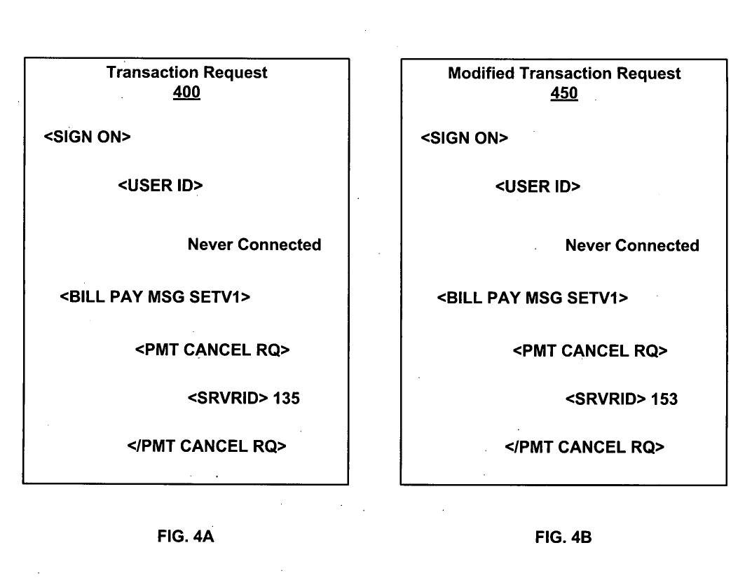

For payment requests, mapping module 220 modifies the transaction request by, for example, switching the first transaction identifier with the second transaction identifier. The modified transaction request allows independent OFX server 150 to carry out the transaction in place of bank OFX server 140, as shown in FIGS. 4A-B. For other transaction requests, mapping module 220 can pass the transaction request without modification to the transaction identifier.

Interface module 240 processes data packets for transmission through a network so that the transmission is seamless to client 140. In one embodiment, interface module 240 allows migration module 130 to pose as the requester of the transaction so that responses to modified transactions are returned directly to migration module 130 rather than client module 110 (e.g., for reverse mapping as described above). Additionally, unmodified transactions can be passed back through migration module 130. To do so, interface module 240 can replace the network addresses of client module 110 with the network address of migration module 130 prior to submitting transaction requests. Furthermore, interface module 240 can present authentication credentials on behalf of client module 110.

FIGS. 4A-B illustrate samples of pseudo code used in a transaction request 400 and a modified transaction request 450, respectively. Transaction and modified transaction requests 400, 450 can be implemented as operable code in OFX, SGML, XML, HTTP, C++, or any other suitable software language.

Transaction request 400 as received from client module 110 can include headers and data. The headers identify data of a specific transaction. A bill pay header includes the first transaction identifier, and a payment cancel header indicates that a certain bill payment is being cancelled. Other action headers for bill payments can include a set-up header, or a make payment header. A server identification header identifies which server within bank OFX server 140 has been designated for bill payments from client module 110.

Modified transaction request 450 is sent to independent OFX server 150 can also include headers and data. However, the transaction identifier has been switched as described above.

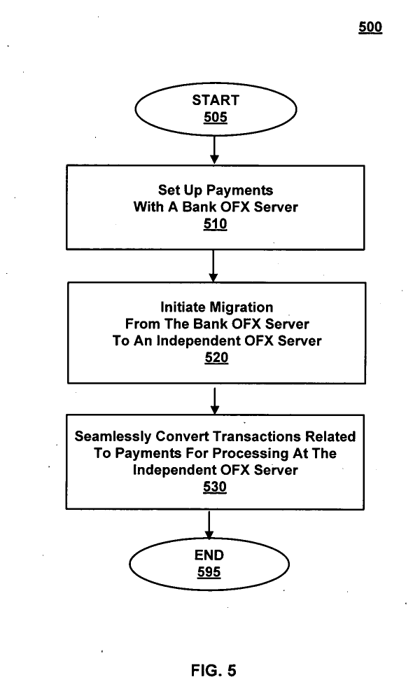

FIG. 5 is a flow chart illustrating a method 500 for seamlessly migrating between payment processors. Method 500 can be implemented by, for example, system 100 which is also means for performing method 500. A user of a client module (e.g., client module 110) sets-up 510 bill payments with a bank OFX server (e.g., bank OFX server 140). More specifically, the user can navigate through a series of user interfaces as presented by a wizard to enter essential information. For example, the user can enter an account number associated with a cell phone provider. The user can designate that the entire amount be automatically paid each month, a certain amount be paid each month, or otherwise. The client module packages the information for transmittal to the bank OFX server which makes sure that the designations are processed in a timely manner. One of ordinary skill in the art will recognize that there are many other variations of bill payments that can be set up within the context of the present invention.

The migration module initiates migration 520 from the bank OFX server to the independent OFX server. The migration can be due to a change in back-end processing systems. Thus, rather than requiring a bank to provide the technical capability and server capacity for an increasing number of payment transactions, a third-party can takeover.

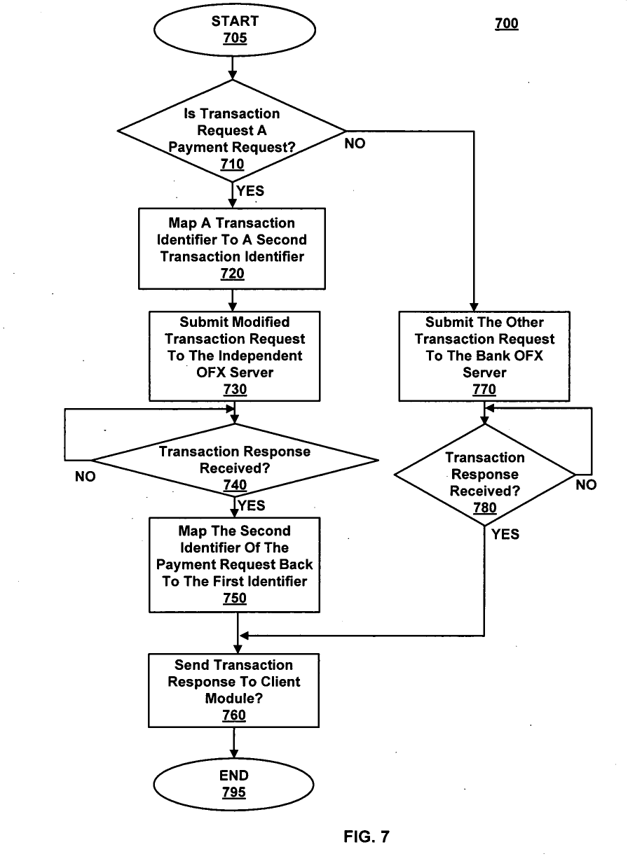

The migration module seamlessly converts 530 transactions related to payments for processing at with the independent OFX server. From the perspective of the client module, the process of making payment requests is the substantially the same. That is, the client module does not have the burden of canceling and reestablishing transaction instructions. The step of converting is described in more detail in FIG. 7.

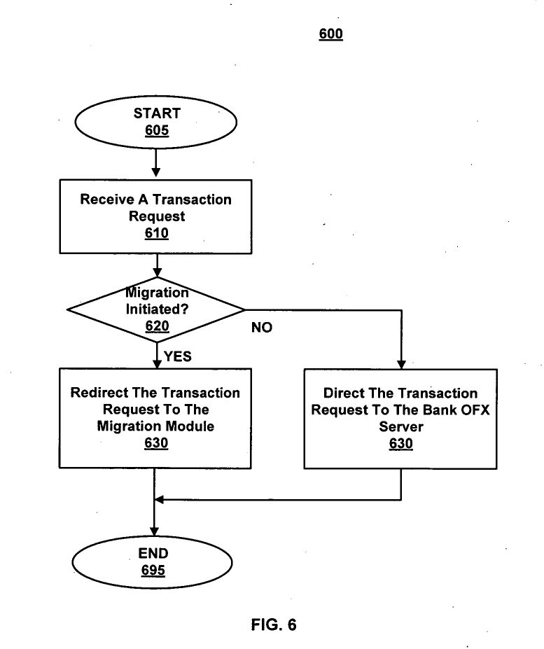

FIG. 6 is a flow chart illustrating one embodiment of a method 600 for redirecting transaction requests. Method 600 can be implemented by, for example, pointer module 120 which is also means for performing method 600. A transaction request is received 610 from the client module. The client module can be configured by a manufacturer to start network transactions with the pointer module as a single point of contact for payment processors at various network locations. The pointer module examines the transaction request (or a portion of a transaction request) to determine a network location (e.g., a URL) for carrying out the transaction. For example, transactions using funds from a Bank of America account can be directed towards a specific server at Bank of America. The network locations of payment processors can be changed from time to time such as when a new server is added. Thereby, updates to network locations can be tracked by the manufacturer and changed centrally rather than at each client module.

In one embodiment, the requests are formatted as messages in OFX format and then sent over HTTP. One or more requests can be packaged in an XML file along with other information such as authentication credentials. Examples of OFX messages include a basic message (e.g., <xxxRQ>) that can be used to add bill payments (e.g., <PMTRQ>); a modify message (e.g., <xxxMODRQ>) that can be used to modify bill payments (e.g., <PMTMODRQ>; a delete or cancel message (e.g., <xxxDELRQ>or <xxxCANCRQ>) that can be used to delete payees or delete payments (e.g., <PMTCANCRQ>); an inquiry message (e.g., <xxxINQRQ> that can be used to retrieve messages about existing bill payments (e.g., <PMTINQRQ>).

If migration has been initiated 620, the pointer module redirects 630 the client module to a mapping module (e.g., mapping module 130) rather than a bank OFX server (e.g., bank OFX server 140). More specifically, a network location of the mapping module is sent to the client module for submitting the transaction request. As described in further detail with respect to FIG. 7, the mapping module carries out the transaction request on behalf of the client module, using an independent OFX server (e.g., independent OFX serer 150), and subsequently passes back a transaction response.

If redirection has yet to be initiated 620, the pointer module directs 740 the client module to the bank OFX server. The network location of the bank OFX server can be looked-up in a table that maintains updates. The bank OFX server can send the transaction response directly back to the client module.

FIG. 7 is a flow chart illustrating one embodiment of a method 700 for redirecting payment requests according to one embodiment of the present invention. Method 700 can be implemented by, for example, migration module 130 which is also means for performing method 700. When the transaction request received by the mapping module, a parsing module (e.g., parsing module 220) determines 710 whether the transaction request is a payment request. To do so, an interface module (e.g., interface module 240) first uses a network protocol application to unpack a data stream from network data packets. The data stream can be formatted with metadata which identifies a type for the transaction (e.g., <PMTRQ>) as discussed above. If the transaction request is in fact a payment request, the mapping module maps 720 a first identifier of the payment request to a second identifier of the payment request. The modified transaction request is submitted 830 to the independent OFX server by the interface module.

After the payment request is processed by independent OFX server, the mapping module receives 740 a transaction response. The transaction response is in turn remapped 750 by the mapping module and sent 760 to the client module.

If the transaction request is not a payment request 710, it is submitted 770 by the interface module to the bank OFX server. The transaction response can be passed through the mapping module which sends 760 the transaction response back to the client module.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it may prove convenient to construct more specialized apparatuses to perform the method steps. The required structure for a variety of these systems will appear from the description below. In addition, the present invention is not described with reference to any particular programming language. It will be appreciated that a variety of programming languages can be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A computer-implemented method for migrating between payment processors, the method comprising:
receiving a transaction request from a client, the transaction request including a first transaction identifier associated with a transaction service;
determining that the transaction request includes a payment request;
generating a modified transaction request including mapping a first transaction identifier to a second transaction identifier associated with a payment service; and
submitting the modified transaction request to the payment service for processing.

2. The method of claim 1, further comprising:
prior to receiving the transaction request, retrieving from the payment service a plurality of transaction identifiers and corresponding first transaction identifications;
sending the transaction information to the transaction service;
receiving the second transaction identifier; and
storing the second transaction identifier in association with the first transaction identifier.

3. The method of claim 1, further comprising:
responsive to receiving the transaction requests, retrieving from the payment service a plurality of transaction identifiers and corresponding first transaction identifications;
sending the transaction information to the payment service;
receiving the second transaction identifier; and
storing the second transaction identifier in association with the first transaction identifier.

4. The method of claim 1, wherein the transaction service is not configured to cooperate with migration.

5. The method of claim 1, further comprising:
prior to initiating migration, directing transaction requests from the client directly to the first payment service; and
subsequent to initiating migration, directing transaction requests from the client to a migration module.

6. The method of claim 1, further comprising:
responsive to determining that the transaction request does not include a payment request, submitting the transaction request to the transaction service.

7. The method of claim 1, wherein the payment request comprises a bill payment request.

8. The method of claim 1, wherein the payment service comprises a service using the Automated Clearing House (ACH) network.

9. The method of claim 1, wherein the transaction service comprises a service processed internally by a bank.

10. A computer-implemented method for migrating between payment processors, the method comprising:
receiving a modified payment request that originated as a payment request sent from a client module, the payment request comprising a first transaction identifier associated with a payment service, the modified transaction request including a second transaction identifier that has been mapped from the first transaction identifier; and
processing the modified transaction request on behalf of the client module; and
sending a transaction response based on the processing.

11. A computer readable memory storing a computer program executable by a processor, the computer program performing a method for migrating between payment processors, the method comprising:
receiving a transaction request from a client, the transaction request including a first transaction identifier associated with a transaction service;
determining that the transaction request includes a payment request;
generating a modified transaction request including mapping a first transaction identifier to a second transaction identifier associated with a payment service; and submitting the modified transaction request to the payment service for processing.

12. The computer program product of claim 11, further comprising:
prior to receiving the transaction request, retrieving from the payment service a plurality of transaction identifiers and corresponding first transaction identifications;
sending the transaction information to the transaction service;
receiving the second transaction identifier; and
storing the second transaction identifier in association with the first transaction identifier.

13. The computer program product of claim 11, further comprising:
responsive to receiving the transaction requests, retrieving from the payment service a plurality of transaction identifiers and corresponding first transaction identifications;
sending the transaction information to the payment service;
receiving the second transaction identifier; and
storing the second transaction identifier in association with the first transaction identifier.

14. The computer program product of claim 11, wherein the transaction service is not configured to cooperate with migration.

15. The computer program product of claim 11, further comprising:
prior to initiating migration, directing transaction requests from the client directly to the first payment service; and
subsequent to initiating migration, directing transaction requests from the client to a migration module.

16. The computer program product of claim 11, further comprising:
responsive to determining that the transaction request does not include a payment request, submitting the transaction request to the transaction service.

17. The computer program product of claim 11, wherein the payment request comprises a bill payment request.

18. A system for migrating between payment processors, comprising:
an interface configured to receive a transaction request from a client, the transaction request intended for processing by a first payment processor;
a parsing module, in communication with the interface, the parsing module configured to determine that the transaction request includes a payment request; and
a migration module, in communication with the parsing module, the migration module configured to generate a modified transaction request including mapping a first payee identifier associated with the first payment processor to a second payee identifier associated with a second payment processor, the first and second identifiers being indicative of a payee,
wherein the interface is configured to submit the modified transaction request to the second payment processor for processing.

19. The system of claim 18, wherein prior to receiving the transaction request, the migration module retrieves from the payment service a plurality of transaction identifiers and corresponding first transaction identifications, the migration module sends the transaction information to the transaction service, receives the second transaction identifier, and stores the second transaction identifier in association with the first transaction identifier.

20. The system of claim 18, wherein responsive to receiving the transaction requests, the migration module retrieves from the payment service a plurality of transaction identifiers and corresponding first transaction identifications, the migration module sends the transaction information to the payment service, receives the second transaction identifier, and stores the second transaction identifier in association with the first transaction identifier.

21. The system of claim 18, wherein the transaction service is not configured to cooperate with migration.

22. The system of claim 18, further comprising a pointer module that, prior to initiating migration, directs transaction requests from the client directly to the first payment service, and subsequent to initiating migration, the pointer module directs transaction requests from the client to the interface.

23. The system of claim 18, wherein responsive to determining that the transaction request does not include a payment request, the migration module submits the transaction request to the transaction service.

24. The system of claim 18, wherein the payment request comprises a bill payment request.

25. The system of claim 18, wherein the payment service comprises a service using the Automated Clearing House (ACH) network.

26. The system of claim 18, wherein the transaction service comprises a service processed internally by a bank.

27. A system for seamlessly migrating between payment processors, comprising:
means for migrating to receive a transaction request from a client, the transaction request intended for processing by a first payment processor, means for migrating to determine that the transaction request includes a payment request, means for migrating to generate a modified transaction request including mapping a first payee identifier associated with the first payment processor to a second payee identifier associated with a second payment processor, the first and second identifiers being indicative of a payee, means for migrating to submit the modified transaction request to the second payment processor for processing.
